(19) United States
(12) Patent Application Publication
(10) Pub. No.: US 2024/0137770 A1
(43) Pub. Date: Apr. 25, 2024

(54) TREATMENT OF MALICIOUS USER EQUIPMENT IN A WIRELESS COMMUNICATION NETWORK

(71) Applicant: Telefonaktiebolaget LM Ericsson (publ), Stockholm (SE)

(72) Inventors: Christian SKÄRBY, Stockholm (SE); Jonathan OLSSON, Sollentuna (SE); Prajwol Kumar NAKARMI, Sollentuna (SE); Walter MÜLLER, Upplands Väsby (SE); Loay ABDELRAZEK, Danderyd (SE)

(21) Appl. No.: 18/279,850

(22) PCT Filed: Mar. 9, 2021
(86) PCT No.: PCT/SE2021/050205

§ 371 Date: Aug. 30, 2023

(51) Int. Cl. H04W 12/122

(52) U.S. Cl. CPC H04W 12/122

(57) ABSTRACT

A method is disclosed for handling a radio communication of a malicious user equipment, UE, in a wireless communication network. The method is performed by at least one network node in the wireless communication network. The method includes obtaining information identifying the malicious UE attached to the wireless communication network. The method includes performing at least one action to deter or delay serving the malicious UE without terminating the radio communication of the malicious UE with the wireless communication network. Further, the method includes controlling allocation of resources to the malicious UE to allow the malicious UE to retain the radio communication with the wireless communication network. Corresponding network node, and computer program products are also disclosed.

### TECHNICAL FIELD

The present disclosure relates to the field of wireless communication. More particularly, the present disclosure relates to method, network node and computer program products for handling radio communication of a malicious User Equipment, UE, in a wireless communication network.

### BACKGROUND

With the advent of mobile broadband, various electronic devices such as smart phones, and other mobile devices have acquired the capability of communicating with the Internet over mobile-communications networks. Due to this capability, mobile operators have become internet-service providers, ISPs, in addition to functioning in their traditional role of providing cellular voice services.

Today's mobile broadband wireless networks with expanded voice and data capabilities are increasingly becoming vulnerable to cyber-attacks because of rapid growth in packet data traffic in these networks. As opposed to most wireline links, wireless links tend to have a much more limited bandwidth. The radio interface of the wireless networks is one of the most exposed interfaces in a mobile network, that makes it subject to different forms of air interface attacks that have taken different forms and have evolved in recent years to more advanced types of attacks. Recently, attackers are using advanced tactics that do not rely on increasing the traffic volume, by manipulating the air interface protocol stacks and functions to achieve a stealthier and more targeted attacks.

Threats against the air interface are structured attacks originating either from a compromised device like mobile phones or a tailored-software based User Equipment, UE, acting as a malicious device. The purpose of attacks originating from UE is primarily to disrupt services, including preventing other UEs from connecting to the network, forcing connected UEs to disconnect from the network, or degrading service performance (partial or complete denial of service). These attacks mainly target specific functions in the radio base station, which may impact all devices in a cell. Large-scale attacks including many malicious devices controlled by an attacker could be coordinated to disrupt services over a large geographic area.

The air interface protocol stack has been developed and standardized with an implicit assumption of full trust of the devices that are being served by the network. The continuous belief that the telecommunication infrastructure is a walled garden led to attacks originating from the UEs or devices were not taken into consideration. Thus, the steps taken to protect the air interface are directed towards protecting the subscribers from integrity and confidentially threats. On the other hand, the current prevention controls may not be fully effective against evolving attacks where malicious devices can impersonate different characteristics to bypass the static controls that rely on QoS or other radio characteristics.

FIG. 1A illustrates a high-level architecture of a UE. The UE is normally composed of application layer that focuses on process to process communication across an IP network it includes audio, video and graphics applications. A middleware layer, the OS and kernel layer and the baseband, BB, layer that processes the radio communication. These combined parts are also referred to as Mobile Equipment, ME.

A UE originating an attack could categorized into two categories namely a UE with non-compromised baseband, and a UE with compromised baseband. In case of Distributed Denial of Service, DDoS, types of attacks, the main aim of such attacks are to flood the network with traffic. The traffic can be control plane traffic which is responsible for management of resources, or user plane traffic which carry the actual data like a video call. The control plane traffic is also known as signaling traffic. The impact of DDoS attacks may not only lead to user plane storms, but also signaling storms that impact resources allocated to other UEs that are in the same cell as the compromised UE.

In case of the UE with compromised baseband, the attacker will have full or partial control over the control plane protocol stack. This is shown in FIG. 1B. This type of advanced attacks mainly target manipulating protocol structure and functions, to impact the Radio Access Network, RAN functions consisting of base stations and Core Network, CN functions. For example, UE with compromised baseband may send reports to the network to ask for resources that may not actually be used, thus the base station may allocate resources as requested by that UE and deprive the available resources in the cell for other legitimate UEs.

### SUMMARY

An object of the present disclosure is to provide an improved mechanism for handling radio communication of malicious user equipment in a wireless communication network.

It is therefore an object of the present disclosure to provide a method, a network node and a computer program product for handling radio communication of a malicious UE, which seeks to mitigate, alleviate, or eliminate all or at least some of the above-discussed drawbacks of presently known solutions.

This and other objects are achieved by means of a method, a computer program product, and a device as defined in the appended claims. The term exemplary is in the present context to be understood as serving as an instance, example or illustration.

According to a first aspect of the present disclosure, a method for handling radio communication of a malicious user equipment, UE, in a wireless communication network is provided. The method is performed by a network node, for example, a base station in the wireless communication network. The method comprises obtaining information identifying the malicious UE attached to the wireless communication network. Further, the method comprises performing at least one action to deter or delay serving the malicious UE without terminating the radio communication of the malicious UE with the wireless communication network.

In some embodiments, the method further comprises controlling allocation of resources to the malicious UE to allow the malicious UE to retain the radio communication with the wireless communication network.

In some embodiments, the step of performing at least one action to deter or delay serving the malicious UE without terminating the radio communication of the malicious UE with the wireless communication network comprises one or more of transmitting a random access response, RAR, message to the malicious UE after receiving a pre-defined number of random access preambles from the malicious UE, transmitting an anonymous response message to the malicious UE, the anonymous response message being a non-relevant message to the malicious UE, in response to a radio resource control, RRC connection request from the malicious UE, transmitting a response message to the malicious UE in response to a retransmitted request message from the malicious UE, transmitting multiple negative acknowledgement, NACK, messages to the malicious UE to allow the malicious UE to perform retransmissions of the transmitted data by the malicious UE, transmitting a response message to the malicious UE before expiry of a pre-determined time interval for transmitting the response message and ignoring to respond to the malicious UE.

In some embodiments, the step of controlling allocation of resources to the malicious UE comprises scheduling a pre-determined number of resource blocks to the malicious UE.

In some embodiments, the method further comprises performing at least one action to, deter or delay a possible malicious attack on said wireless communication network by the malicious UE.

In some embodiments, performing at least one action to, deter or delay a possible malicious attack on said wireless communication network by the malicious UE comprises one or more of dropping a received packet, forwarding the received packet to an intrusion analysis tool, logging information associated with the received packet, determining a source of the received packet, sending a response to the received packet and ignoring to send a response to the received packet.

In some embodiments, the network node is one or more of a radio access network including a base station, a cloud radio access Network, a core network including access and mobility management function, AMF, session management function, SMF, mobility management entity, MME, Serving GPRS Support Node, SGSN, packet data network gateway, P-GW, serving gateway, S-GW, and user plane function, UPF, a near real time radio intelligent controller, RIC, a non-near real time RIC, or a software-defined networking, SDN, controller.

According to a second aspect of the present disclosure, a network node for handling radio communication of a malicious UE, in a wireless communication network is provided. The network node comprising a processor, and a memory storing instructions when executed by the processor cause the network node to obtain information identifying the malicious UE attached to the wireless communication network. Further, the instructions when executed by the processor cause the network node to perform at least one action to deter or delay serving the malicious UE without terminating the radio communication of the malicious UE with the wireless communication network.

According to a third aspect of the present disclosure, there is provided a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

An advantage of some embodiments is that alternative and/or improved approaches for handling radio communication of a malicious UE in the wireless communication network are provided.

An advantage of some embodiments is that the proposed method allows for preventing and/or delaying the malicious UE without affecting other legitimate UEs in the wireless communication network.

An advantage of some embodiments is that the proposed method allows for mitigation of detected air interface attacks by malicious behaving devices or UEs or crafted software defined radio based devices.

Additionally, the proposed method can be used to disrupting the attack procedure by the malicious UEs. This results in the attack being delayed or halted and/or slowed down.

An advantage of some embodiments is that the proposed method allows for controlled allocation of resources to the malicious UEs in an adaptive and illusive manner by allocating minimal network resources to allow the malicious UE to retain the radio communication with the wireless communication network. Therefore, with the proposed method, the malicious UE will not realize that the network is mitigating the attack from the malicious UE.

An advantage of the some embodiments is that the air interface resources and computing resources of the base band can be protected.

Additionally, the proposed method can be applied individually on each of the malicious UE without affecting other legitimate UEs in the wireless communication network.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1A discloses a schematic of a user equipment, UE, according to prior art;

FIG. 1B discloses a protocol stack at the UE, base station and core network, according to prior art;

FIG. 2 discloses an example wireless communication network according to some embodiments;

FIG. 3 is a flowchart illustrating example method steps according to some embodiments;

FIG. 4 is an example schematic diagram of a network node according to some embodiments; and

FIG. 5 discloses an example computing environment according to some embodiments.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the present disclosure, user equipments, UEs, also known as mobile terminals, and/or wireless terminals are enabled to communicate wirelessly with a network node in a wireless communication network.

Typically, a network node may serve or cover one or several cells of the wireless communication network. That is, the network node provides radio coverage in the cell(s) and communicates over an air interface with the UE(s) operating on radio frequencies within its range. The network node may be also referred to as “eNB”, “eNodeB”, “NodeB” or “gNB”, depending on the technology and terminology used.

In the following description of exemplary embodiments, the same reference numerals denote the same or similar components.

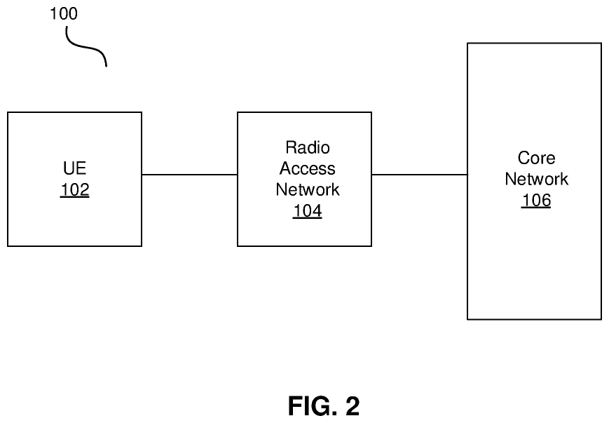

FIG. 2 discloses an example wireless communication network according to some embodiments. As depicted in FIG. 2, the wireless communication network 100 includes a user equipment, UE 102 a radio access network, RAN 104 and a core network 106. The UE 102 may be a mobile device or an electronic device that connects to the RAN 104.

The RAN 104 can be for example a new radio, NR, base station i.e., a gNB or an evolved node base station i.e., eNB, or the like. The UE 102 communicates with the base station serving the UE 102. The communication from the base station to the UE 102 is referred to as downlink, DL, communication, whereas communication from the UE to the base station is referred to as uplink, UL, communication. Thus, the UE 102 involves in bidirectional radio communication with the base station. There can be a plurality of UEs 102a-102n (not shown) in the coverage of the base station 104.

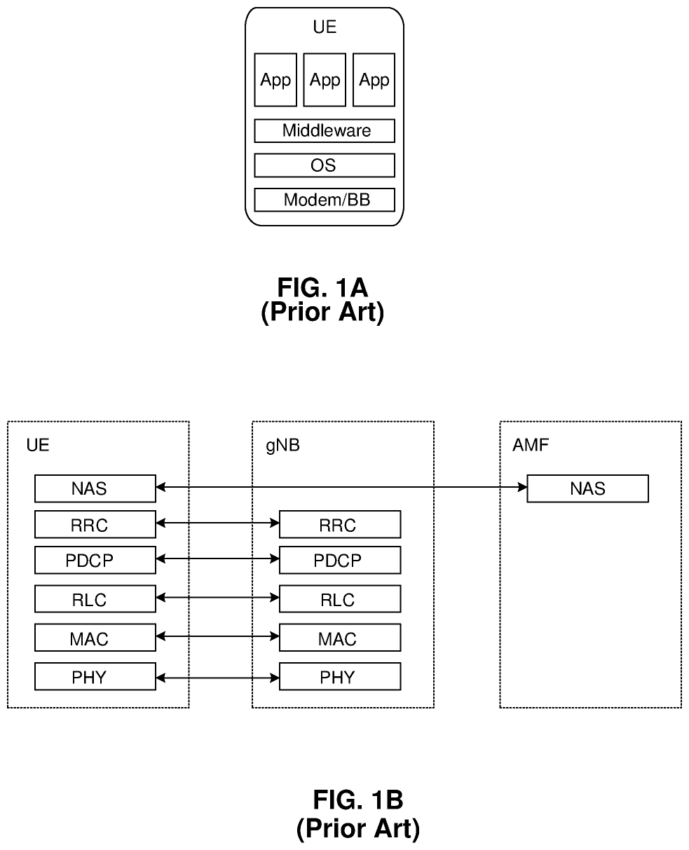

The CN 104 may include a Control Plane, CP and a User Plane, UP (not shown in FIG. 1). The UE 102 communicates with one or more network nodes or service nodes in the CN 104 typically to obtain a service via connections through a node in the RAN 104 and then through the CN 104. Packet Data Units, PDUs, between the UE 102 and the network node in the CN 106 are transmitted through the AN 104 and the CN 106.

The UE 102, the RAN 104 and the CN 106 are interconnected to enable delivery of various services to the UE 102. It should be noted that, for clarity, FIG. 2 shows only the network entities that are relevant to the description of various embodiments of the disclosure. One skilled in the art will understand that wireless communication network 100 in general and core network 106 in particular may have additional entities not explicitly shown in FIG. 2.

In addition to the RAN 104 shown in FIG. 2, the wireless communication network 100 typically has a plurality of additional access nodes (not explicitly shown in FIG. 2). In a representative embodiment, access node includes a base-station transceiver (not explicitly shown) that maintains wireless link with the UE 102. The access node 110 further includes a radio controller (not explicitly shown) that controls the base-station transceiver. The radio controller typically performs radio-resource management and certain mobility-management functions.

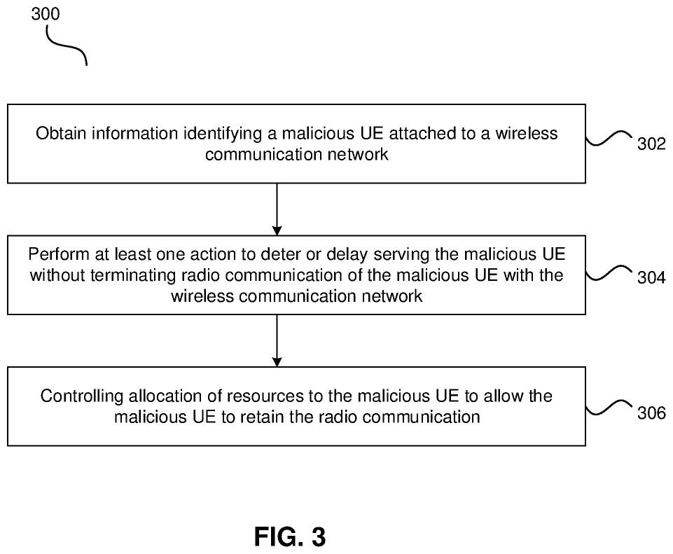

FIG. 3 is a flowchart illustrating an example method 300 according to some embodiments.

The method 300 is described in reference to both FIGS. 2 and 3. The description assumes that the UE 102 is a malicious (e.g., malware-infected) UE that has gained access to the wireless communication network 100 through an access node in the RAN 104 and attempts to perform illegal actions, e.g., actions that violate security policies, security practices, and/or use policies.

The method 300 is for handling radio communication of a malicious UE 102 in the wireless communication network 100. A typical example where the method 300 may be applicable is when the malicious UE 102 has attached to the wireless communication network 100, but not yet established a connection for communication with the wireless communication network 100.

In some examples, the method 300 may be initiated upon detection of the malicious UE 102 which is attached to the wireless communication network 100.

For example, the method 300 may be performed by a network node (e.g., the network node may be present in CN 106 in FIG. 1) and/or in the RAN 104 in FIG. 1. In some examples, the network node can be a network function in the CN 106 or in the RAN 104.

Further, the network node can be a radio access network including a base station, a cloud radio access Network, a core network including access and mobility management function, AMF, session management function, SMF, mobility management entity, MME, Serving GPRS Support Node, SGSN, packet data network gateway, P-GW, serving gateway, S-GW, and user plane function, UPF, a near real time radio intelligent controller, RIC, a non-near real time RIC, or a software-defined networking, SDN, controller.

In some implementations, the network node, can be for example, a remote computer or a server hosted in the wireless communication network 100 in FIG. 1. The steps illustrated in FIG. 3 may be performed for one network node, for some network nodes, or for each network node in the CN 106 and/or in the RAN 104 in FIG. 1.

In some embodiments, the method 300 may be performed by one or more network nodes residing in a cloud network.

At step 302, the method 300 comprises obtaining information identifying the malicious UE 102 attached to the wireless communication network 100. For example, the network node may obtain the information identifying the malicious UE 102 attached to the wireless communication network 100 from any of the network entities in the CN 106.

In some examples, the network entities in the CN 106 may utilize malicious UE detection and/or identification techniques for identifying the malicious UE 102 attached to the wireless communication network 100.

In an example, the malicious UE 102 may be detected by monitoring data packets that are transported from the malicious UE 102 through corresponding access nodes (in the RAN 104) and an IP network.

Thus, the network node obtains the information identifying the malicious 100 UE attached to the wireless communication network 100.

At step 304, the method 300 comprises performing at least one action to deter or delay serving the malicious UE 102 without terminating the radio communication of the malicious UE 102 with the wireless communication network 100.

In some examples, the network node may introduce one or more deliberate delays into communication protocol messages with the malicious UE 102. Example of the communication protocol exchanges defined in the Third Generation Partnership Project, 3GPP, includes Radio Resource Control, RRC, Non-Access Stratum, NAS, Medium Access Control, MAC, Packet Data Convergence Protocol, PDCP.

In an example, the network node may delay the malicious UE 102b from reaching a state potentially unfavourable wireless communication network 100. By delaying the malicious UE 102, the network node may have necessary time to perform various operations including but not limited to freeing up memory, cleaning disk storage, update firewall rules, or instantiate new network function instances, or the like.

In an embodiment, the action performed by the network node to deter or delay serving the malicious UE 102 without terminating the radio communication of the malicious UE 102 with the wireless communication network 100 comprises transmitting a random access response, RAR, message to the malicious UE 102b after receiving a pre-defined number of random access preambles from the malicious UE 102b.

For example, the network node may transmit a response message i.e., a RAR message to the malicious UE 102 only after receiving a pre-defined number of signalling messages from the malicious UE 102. It should be noted that the pre-defined number may be configured or randomly selected from a pre-defined range. In an example, the network node may respond to a Random Access Preamble, i.e., message 1, from the malicious UE 102 only after getting 10 other Random Access Preambles. Thus, the network node responds to the malicious UE 102 with a delay which in-turn causes a delay for the malicious UE 102 in performing the random access procedure. Therefore, the malicious UE 102 is delayed deliberately by not responding to the malicious UE 102 which also allows legitimate UEs to establish connection with the wireless communication network 100.

In an embodiment, the network node transmits an anonymous response message to the malicious UE, in response to a radio resource control, RRC connection request from the malicious UE 102b. The anonymous response message is a non-relevant message to the malicious UE 102b.

In an example, the network node responds to the malicious UE 102 with an unexpected response message. In case of a Contention Based Random Access, CBRA, procedure, where the malicious UE 102 sends a RRC Request which is termed as a message 3 with a random value, then the network node i.e., a gNB sends the malicious UE 102, a Contention Resolution Identify message which is not expected by the malicious UE 102. When the network node responds to the malicious UE 102 with an unexpected response message, the malicious UE 102 may send another RRC request message to the gNB which delays the malicious UE 102 from sending RRC Complete, thereby delaying the malicious UE 102 from completing the RRC connection establishment procedure with the network node.

In some embodiments, the network node transmits a response message to the malicious UE 102 in response to a retransmitted message from the malicious UE 102. For example, the network node responds to the malicious UE 102 with a response message that is expected the malicious UE after receiving a retransmitted message from the malicious UE 102. The retransmitted message from the malicious UE 102 may include a Scheduling Request on PUCCH or RACH, RLC status and HARQ feedback.

In some embodiments, the network node may transmit multiple negative acknowledgement, NACK, messages to the malicious UE 102 to allow the malicious UE 102 to perform retransmissions of the transmitted data.

For example, the network node transmits continuous negative acknowledgement, NACK, messages to the malicious UE 102, thereby allowing the malicious UE 102 to retransmit the last sent packets. The network node responds to the malicious traffic carried on Physical Uplink Shared Channel PUSCH using the hybrid-ARQ ACK/NACK that is sent back on the Physical HARQ Indicator Channel, PHICH by setting the NACK bit. Thus, the transmission of continuous NACK messages by the network node enables the malicious UE 102 resend the same packets, so that the malicious UE 102 will not sense that the network node is mitigating the attack.

In some embodiments, the network node transmits a response message to the malicious UE 102 before expiry of a pre-determined time interval for transmitting the response message. For example, the network node transmits a RAR message just before maximum allowed random access response time interval is about to expire, thereby delaying the malicious UE 102.

In some embodiments, the network node ignores to respond to messages from the malicious UE 102, thereby delaying the malicious UE 102 for an unlimited time interval, i.e., an infinite delay.

Thus, the network node may perform one or more of the above described actions to deter or delay serving the malicious UE 102 without terminating the radio communication of the malicious UE 102 with the wireless communication network 100.

At step 306, the method 300 comprises controlling allocation of resources to the malicious UE 102 to allow the malicious UE 102 to retain the radio communication with the wireless communication network 100.

In some examples, the network node may control the number of grants and/or resource allocations to the malicious UE 102 by only responding to the messages which are necessary to retain the malicious UE 102 connected to the wireless communication network 100.

For example, in Uplink Grants, to the malicious UE 102 to enable the malicious UE 102 to transmit data on uplink, the network node may send limited number of resource block assignment value that is included in the downlink control information, DCI. Thus, the malicious UE 102 shall only be constrained to the limited number of resource blocks scheduled and assigned to it. Thus, by controlling the number of grants and/or resource allocations, the malicious UE 102 shall be prevented from consuming the air interface resources and may also cause disruption to the service for the malicious UE 102.

In some scenarios, the above described wireless communication network 100 may still be vulnerable to malicious attacks. As such, the present disclosure provides a way to deter and delay attacks on the wireless communication network 100. The present disclosure employs various techniques to deter and delay the attacks by the malicious UE 102.

In some embodiments, identity values of the data packets may be used to detect suspect packets from the malicious UE 102, indicating that there is a possible malicious attack on the wireless communication network 100. Once a possible malicious attack has been detected, one or more actions may be performed by the network node so as to deter and/or delay the malicious attack. Such actions can include, but are not limited to dropping a received packet from the malicious UE, forwarding the received packet to an intrusion analysis tool, logging information associated with the received packet, determining a source of the received packet, sending a response to the received packet and ignoring to send a response to the received packet, or the like.

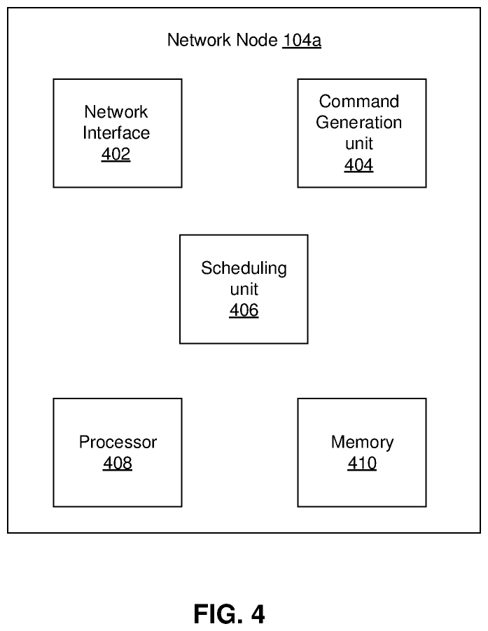

FIG. 4 is an example schematic diagram of a network node 104a according to some embodiments. The network node 104a may reside in the RAN 104 or in the CN 106 of the wireless communication network 100 as in FIG. 2. Further, the network node may be capable of handling radio communication of the malicious UE and may comprise means arranged to perform the method for handling radio communication of the malicious UE as described in relation to FIG. 3.

According to at least some embodiments of the present disclosure, the network node 104 in FIG. 4 comprises a network interface 402, a command generation unit 404, a scheduling unit 406, a processor 408 and a memory 410.

The network interface 402 may be adapted to receive and transmit for example, user data or control signalling from the AN 104 or the CN 106 as shown in FIG. 1.

In some examples, the network node 104a may be adapted to obtain the information identifying the malicious UE, through the network interface 402 corresponding to the step 302 in FIG. 3.

Further, the network node 104a may be adapted to transmit protocol messages to the malicious UE through the network interface 402.

The network interface 402, the command generation unit 404, and the scheduling unit 406 may be operatively connected to each other.

Optionally, the command generation unit 404 may be adapted to generate a command to the malicious UE so as to deter or delay the malicious UE without terminating radio communication of the malicious UE. For example, the command generation unit 404 may be adapted to generate protocol messages such as but not limited to RRC, NAS, MAC, PDCP, or the like.

As described above, the command generation unit 404 may be adapted to generate protocol messages to the malicious UE, a few of which have been mentioned above in connection to the explanation of FIG. 3.

The scheduling unit 406 can be adapted to control allocation of resources to the malicious UE to allow the malicious UE to retain the radio communication with the wireless communication network, corresponding to the step 306 of FIG. 3.

The processor 706 may be implemented in hardware, software, or a combination of hardware and software to execute one or more instructions for handling the radio communication of the malicious UE. The memory 708 may store one of more instructions to be executed for obtaining the information identifying the malicious UE attached to the wireless communication network and to perform at least one action to deter or delay serving the malicious UE without terminating the radio communication of the malicious UE.

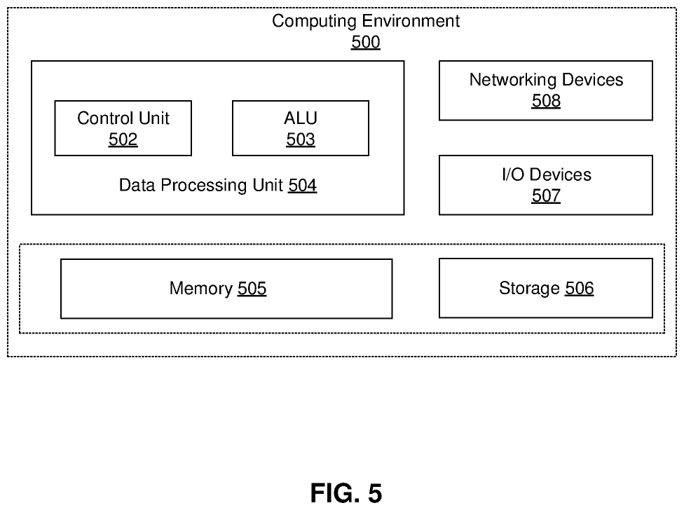

FIG. 5 illustrates an example computing environment 500 implementing a method and the network node for handling radio communication of the malicious UE described in FIG. 3. As depicted in FIG. 5, the computing environment 500 comprises at least one data processing unit 504 that is equipped with a control unit 502 and an Arithmetic Logic Unit, ALU 503, a memory 505, a storage 506, plurality of networking devices 508 and a plurality Input output, I/O devices 507. The data processing unit 504 is responsible for processing the instructions of the algorithm. For example, the data processing unit 504 is equivalent to the processing circuitry of the network node. The data processing unit 504 is capable of executing software instructions stored in memory 505. The data processing unit 504 receives commands from the control unit 502 in order to perform its processing. Further, any logical and arithmetic operations involved in the execution of the instructions are computed with the help of the ALU 503.

The computer program is loadable into the data processing unit 504, which may, for example, be comprised in an electronic apparatus (such as a UE or a network node). When loaded into the data processing unit 504, the computer program may be stored in the memory 505 associated with or comprised in the data processor. According to some embodiments, the computer program may, when loaded into and run by the data processing unit 504, cause execution of method steps according to, for example, the method illustrated in FIG. 3.

The overall computing environment 500 can be composed of multiple homogeneous and/or heterogeneous cores, multiple CPUs of different kinds, special media and other accelerators. The data processing unit 504 is responsible for processing the instructions of the algorithm. Further, the plurality of data processing units 504 may be located on a single chip or over multiple chips.

The algorithm comprising of instructions and codes required for the implementation are stored in either the memory 505 or the storage 506 or both. At the time of execution, the instructions may be fetched from the corresponding memory 505 and/or storage 506, and executed by the data processing unit 504.

In case of any hardware implementations various networking devices 508 or external I/O devices 507 may be connected to the computing environment to support the implementation through the networking devices 508 and the I/O devices 507.

The embodiments disclosed herein can be implemented through at least one software program running on at least one hardware device and performing network management functions to control the elements. The elements shown in FIG. 5 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for handling radio communication of a malicious user equipment, UE, in a wireless communication network, the method being performed by a network node, the method comprising:
obtaining information identifying the malicious UE attached to the wireless communication network; and
performing at least one action to deter or delay serving the malicious UE without terminating the radio communication of the malicious UE with the wireless communication network.

2. The method according to claim 1, wherein the method further comprising:
controlling allocation of resources to the malicious UE to allow the malicious UE to retain the radio communication with the wireless communication network.

3. The method according to claim 1, wherein the step of performing at least one action to deter or delay serving the malicious UE without terminating the radio communication of the malicious UE with the wireless communication network comprises one or more of:
transmitting a random access response, RAR, message to the malicious UE after receiving a pre-defined number of random access preambles from the malicious UE;
transmitting an anonymous response message to the malicious UE, the anonymous response message being a non-relevant message to the malicious UE, in response to a radio resource control, RRC connection request from the malicious UE;
transmitting a response message to the malicious UE in response to a retransmitted request message from the malicious UE;
transmitting multiple negative acknowledgement, NACK, messages to the malicious UE to allow the malicious UE to perform retransmissions of the transmitted data by the malicious UE;
transmitting a response message to the malicious UE before expiry of a pre-determined time interval for transmitting the response message; and
ignoring to respond to the malicious UE.

4. The method according to claim 1, wherein the step of controlling allocation of resources to the malicious UE comprises:
scheduling a pre-determined number of resource blocks to the malicious UE.

5. The method according to claim 1, further comprising:
performing at least one action to, deter or delay a possible malicious attack on said wireless communication network by the malicious UE.

6. The method according to claim 5, wherein performing at least one action to, deter or delay a possible malicious attack on said wireless communication network by the malicious UE comprises one or more of:
dropping a received packet,
forwarding the received packet to an intrusion analysis tool,
logging information associated with the received packet,
determining a source of the received packet,
sending a response to the received packet, and
ignoring to send a response to the received packet.

7. The method according to claim 1, wherein the network node is one or more of: a radio access network including a base station, a cloud radio access Network, a core network including access and mobility management function, AMF, session management function, SMF, mobility management entity, MME, Serving GPRS Support Node, SGSN, packet data network gateway, P-GW, serving gateway, S-GW, and user plane function, UPF, a near real time radio intelligent controller, RIC, a non-near real time RIC, or a software-defined networking, SDN, controller.

8. A network node for handling radio communication of a malicious user equipment, UE, in a wireless communication network, the network node comprising a processor and a memory storing instructions that, when executed by the processor, cause the network node to:
obtain information identifying the malicious UE attached to the wireless communication network; and
perform at least one action to deter or delay serving the malicious UE without terminating the radio communication of the malicious UE with the wireless communication network.

9. The network node according to claim 8, the network node further configured to:
control allocation of resources to the malicious UE to allow the malicious UE to retain the radio communication with the wireless communication network.

10. The network node according to claim 8, wherein the network node configured to perform at least one action to deter or delay serving the malicious UE without terminating the radio communication of the malicious UE with the wireless communication network comprises one or more of:
transmitting a random access response, RAR, message to the malicious UE after receiving a pre-defined number of random access preambles from the malicious UE;
transmitting an anonymous response message to the malicious UE, the anonymous response message being a non-relevant message to the malicious UE, in response to a radio resource control, RRC connection request from the malicious UE;
transmitting a response message to the malicious UE in response to a retransmitted request message from the malicious UE;
transmitting multiple negative acknowledgement, NACK, messages to the malicious UE to allow the malicious UE to perform retransmissions of the transmitted data by the malicious UE;
transmitting a response message to the malicious UE before expiry of a pre-determined time interval for transmitting the response message; and
ignoring to respond to the malicious UE.

11. The network node according to claim 8, wherein the network node configured to control allocation of resources to the malicious UE by:
scheduling a pre-determined number of resource blocks to the malicious UE.

12. The network node according to claim 8, the network node further configured to:
perform at least one action to, deter or delay a possible malicious attack on said wireless communication network by the malicious UE.

13. The network node according to claim 12, wherein the network node configured to perform at least one action to, deter or delay a possible malicious attack on said wireless communication network by the malicious UE comprises one or more of:
dropping a received packet,
forwarding the received packet to an intrusion analysis tool,
logging information associated with the received packet,
determining a source of the received packet,
sending a response to the received packet, and
ignoring to send a response to the received packet.

14. The network node according to claim 8, wherein the network node is one or more of: a radio access network including a base station, a cloud radio access Network, a core network including access and mobility management function, AMF, session management function, SMF, mobility management entity, MME, Serving GPRS Support Node, SGSN, packet data network gateway, P-GW, serving gateway, S-GW, and user plane function, UPF, a near real time radio intelligent controller, RIC, a non-near real time RIC, or a software-defined networking, SDN, controller.

15. A computer program product comprising a non-transitory computer readable medium, having thereon a computer program comprising program instructions. The computer program is loadable into a data processing unit and configured to cause execution of the method according to claim 1 when the computer program is run by the data processing unit.
